(19) United States
(12) Patent Application Publication
(10) Pub. No.: US 2024/0208479 A1
(43) Pub. Date: Jun. 27, 2024

(54) ELECTROMECHANICAL VEHICLE BRAKE

(71) Applicant: ZF Active Safety GmbH, Koblenz (DE)

(72) Inventor: Volker Knop, Ulmen (DE)

(21) Appl. No.: 18/533,476

(22) Filed: Dec. 8, 2023

(30) Foreign Application Priority Data
Dec. 21, 2022 (DE) 102022134392.8

(51) Int. Cl. B60T 13/74; B60T 17/00; F16D 65/00; F16D 65/18

(52) U.S. Cl. CPC B60T 13/746; B60T 17/002; F16D 65/005; F16D 65/18; F16D 2125/40

(57) ABSTRACT

An electromechanical vehicle brake for a motor vehicle is disclosed, having a housing with a piston chamber containing gas, an actuating piston for a brake lining, and an electric motor for driving the actuating piston. The actuating piston can be moved optionally between a retracted position and an extended position, wherein the actuating piston is accommodated movably in the housing, such that an end of the actuating piston directed towards the brake lining protrudes from the housing and an opposite end of the actuating piston is accommodated in the housing. At least one venting unit is accommodated in the housing in order to allow a gas exchange between the piston chamber and the environment. The venting unit comprises a gas-permeable filter element and a holding element for the filter element, and the venting unit is fixed on the housing by the holding element.

### CROSS-REFERENCE TO RELATED APPLICATION

This application claims priority to German Priority Application No. 102022134392.8, filed Dec. 21, 2022, the disclosure of which is incorporated herein by reference in its entirety.

### TECHNICAL FIELD

The disclosure relates to an electromechanical vehicle brake for a motor vehicle.

### BACKGROUND

Due to an electromechanical vehicle brake, it is possible to generate a braking force directly on the wheels of the vehicle.

Electromechanical vehicle brakes generally comprise a housing with a piston chamber containing gas, an actuating piston for a brake lining, and an electric motor for driving the actuating piston, wherein the actuating piston can be moved optionally between a retracted position and an extended position. In its extended position, the actuating piston presses a brake pad against a brake disc of a wheel brake.

The actuating piston is usually accommodated in a gas-tight manner in the piston chamber in order to avoid dirt or other contaminants as well as moisture entering the piston chamber.

Owing to the gas-tight accommodation of the actuating piston in the piston chamber, however, there is a change in the gas pressure in the piston chamber when a temperature change or a piston movement occurs. Such changes in the gas pressure promote wear of the vehicle brake.

Moreover, an increasing number of dynamic braking operations generates an increasing vacuum in the piston chamber on account of wear of the friction linings. However, the tightness of the piston chamber with respect to the environment can only be ensured up to a certain pressure difference between the internal pressure of the piston chamber and the environment. If the specific pressure difference is exceeded, there is the risk that leaks will occur and moisture and dirt particles will be sucked into the piston chamber, and this also promotes the wear of the electric motor vehicle brake.

### SUMMARY

What is needed is an electromechanical vehicle brake which is optimized with regard to service life.

According to the disclosure, an electromechanical vehicle brake for a motor vehicle is disclosed, having a housing with a piston chamber containing gas, an actuating piston for a brake lining, and an electric motor for driving the actuating piston, wherein the actuating piston can be moved optionally between a retracted position and an extended position, wherein the actuating piston is movably accommodated in the housing, such that an end of the actuating piston directed towards the brake lining protrudes from the housing and an opposite end of the actuating piston is accommodated in the housing. At least one venting unit is accommodated in the housing in order to allow a gas exchange between the piston chamber and the environment, wherein the venting unit comprises a gas-permeable filter element and a holding element for the filter element, and the venting unit is fixed on the housing by the holding element.

The vehicle brake according to the disclosure has the advantage that the gas pressure in the piston chamber corresponds at least approximately to the ambient pressure. This means that pressure fluctuations in the piston chamber are reduced, thereby reducing a load on the components of the vehicle brake, which in turn has an advantageous effect on the service life of the vehicle brake. For example, a pressure difference between the piston chamber and the environment is avoided, thereby preventing leaks of the vehicle brake and thus minimizing the risk of moisture and dirt particles entering the piston chamber. In other words, the venting unit promotes pressure equalization between the piston chamber and the environment. In this way, the risk of condensation forming in the piston chamber is also minimized.

The filter element can be fixed to the housing in a simple manner by due to the holding element.

For example, the venting unit is pre-assembled, thus enabling it to be fixed to the housing in a single assembly step.

The filter element is configured to be impenetrable to dirt particles.

The gas contained in the piston chamber is, for example, air, for example, atmospheric air.

The gas exchange via the venting element can take place in both directions.

For example, the housing has at least one aperture, wherein the venting unit is accommodated in the at least one aperture or covers the at least one aperture.

Thus, the venting unit makes the aperture impenetrable to dirt particles.

The venting unit can be secured on an inner side or an outer side of the housing or protrude through the housing. This allows more flexible positioning of the venting unit.

For example, latching elements are integrally formed on the holding element, wherein the holding element protrudes through an aperture in the housing and is latched on the housing. As a result, the venting unit can be mounted easily and without the use of a separate fastening arrangement. Specifically, the venting unit can be inserted into the aperture and latched with a single movement of the hand.

According to a further exemplary arrangement, a thread is formed on the holding element, and the holding element is screwed into an aperture in the housing. A thread also enables the venting unit to be easily mounted in an aperture without the need for a separate fastening arrangement. In addition, a thread provides improved sealing between the housing and the venting unit.

According to another exemplary arrangement, the holding element is adhesively bonded or welded to the housing. Particularly good sealing between the housing and the venting unit is likewise achieved by this arrangement.

The filter element is, for example, overmoulded along its outer edge with the material that forms the holding element. The filter element is thus secured on the holding element in a reliable manner. Moreover, leaks along an outer edge of the filter element are avoided.

Alternatively, the filter element can be adhesively bonded or welded to the holding element.

By way of example, a seal is arranged between the venting unit and the housing, for example between the holding element and the housing. The seal ensures that pressure equalization between the piston chamber and the environment takes place via the filter element and not via any gap that may occur between the venting unit and the housing. The seal is present especially when the venting unit is latched in the housing or, in other words, when there is no material bond between the venting unit and the housing or when the venting unit is not screwed into the housing.

A collar can be integrally formed on the housing, and the venting unit can be surrounded by the collar. The collar thus shields the venting element laterally, thereby protecting the venting unit from mechanical damage.

At least one venting channel is formed in the holding element, which channel is covered by the filter element. As a result, the venting channel is impenetrable to dirt particles, but gas-permeable.

A support surface for the filter element is preferably formed on the holding element. To be more precise, the filter element rests on the holding element adjacent to the at least one venting channel, as a result of which the filter element is supported and elastic deformation of the filter element is limited. This extends the service life of the filter element.

The presence of a plurality of venting channels in the holding element is advantageous compared to a single venting channel with the same overall flow cross section in terms of supporting the filter element, since in this case support surfaces for the filter element are present between the venting channels.

In an alternative exemplary arrangement, the filter element is supported by the housing.

According to one exemplary arrangement, the holding element is annular. A holding element of this type can be produced in a simple and low-cost manner.

The venting unit can have a cover for covering the filter element, wherein the cover has at least one inlet opening arranged in a side wall of the cover. The cover provides additional protection of the filter element from contamination and mechanical damage, while the gas exchange can take place via the at least one inlet opening in the side wall.

According to one exemplary arrangement, the housing and the holding element are shaped in such a way that a meandering venting channel is formed between the housing and the holding element. By virtue of the meandering shape of the venting channel, the flow path to the filter element is extended, making it less easy for dirt particles to reach the filter element.

### BRIEF DESCRIPTION OF DRAWINGS

Further advantages and features of the disclosure will be found in the following description and in the accompanying drawings, to which reference is made.

In the drawings:

FIG. 1 shows a vehicle brake according to the disclosure,

FIG. 2 shows a cross section through the vehicle brake according to the disclosure,

FIG. 3 shows a part of the vehicle brake according to the disclosure in an exploded view,

FIG. 4 shows a sectional view in the region of a venting unit of the vehicle brake,

FIG. 5 shows a sectional view in the region of a venting unit according to a further exemplary arrangement, and

FIG. 6 shows a sectional view in the region of a venting unit according to yet another exemplary arrangement.

### DETAILED DESCRIPTION

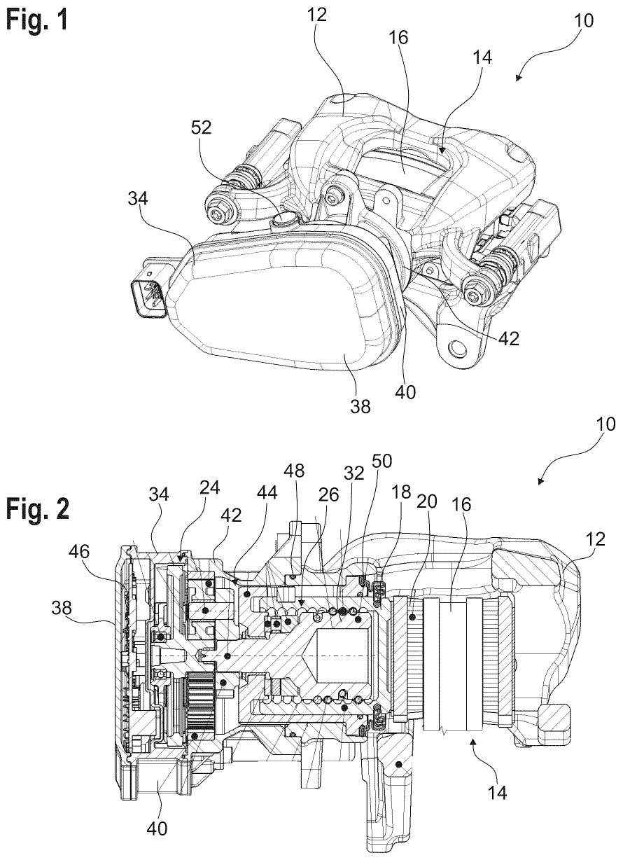

FIG. 1 shows an electromechanical vehicle brake 10.

The vehicle brake 10 comprises a brake caliper 12, in which a space 14 for a brake rotor 16 is formed.

In addition, the vehicle brake 10 has an actuating piston 18 for a brake lining 20, as can be seen in the sectional illustration in FIG. 2.

The actuating piston 18 can be moved optionally between a retracted position and an extended position.

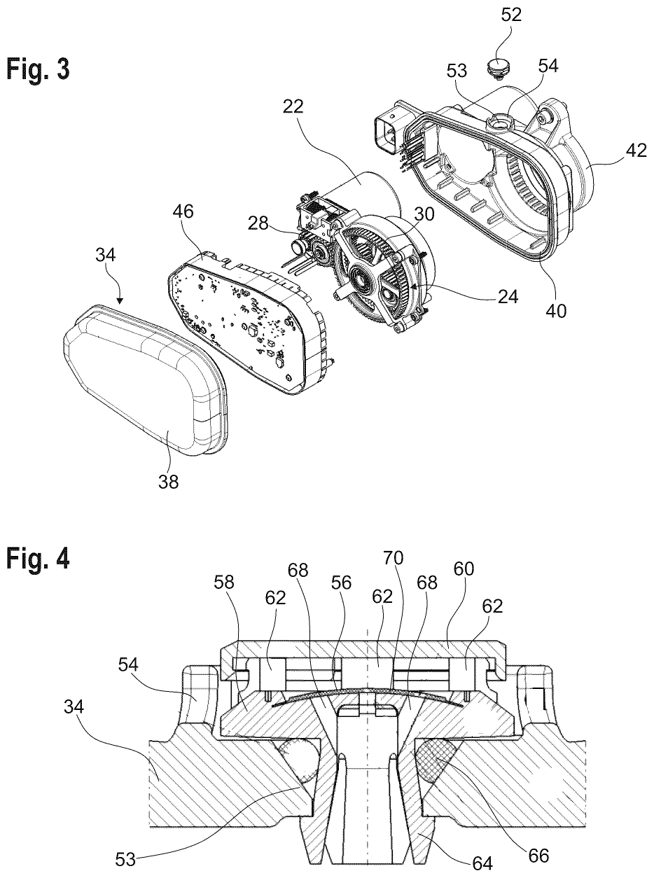

The actuating piston 18 is driven by an electric motor 22 (see FIG. 3).

Specifically, a drive torque generated by the electric motor 22 is transmitted to the actuating piston 18 and converted into a linear movement of the actuating piston 18 by a transmission unit 24 and a spindle drive 26 driven by the transmission unit 24.

In the exemplary arrangement, the transmission unit 24 comprises a drive wheel 28 and a planetary transmission 30, as can be seen in FIG. 3. However, other exemplary arrangements are also conceivable.

The spindle drive 26 comprises a spindle 32, which in the exemplary arrangement is designed as a ball screw spindle.

Furthermore, the vehicle brake 10 comprises a housing 34.

The housing 34 is of multi-part design and comprises two housing shells 38, 40 and a sleeve-shaped section 42. However, a different division of the housing 34 is also conceivable.

With its end close to the brake rotor 16, the housing 34 is fitted partially onto the brake caliper 12.

Specifically, the sleeve-shaped section 42 of the housing 34 is fitted onto the brake caliper 12 and screwed thereto.

The housing 34 has a piston chamber 44 containing gas.

The piston chamber 44 accommodates the transmission unit 24, the spindle drive 26, and a control assembly 46.

The actuating piston 18 is movably accommodated in the housing 34, such that an end of the actuating piston 18 directed towards the brake lining 20 protrudes from the housing 34, and an opposite end of the actuating piston 18 is accommodated in the housing 34.

As can be seen in FIG. 2, there is a seal 48 between the sleeve-shaped section 42 of the housing 34 and the brake caliper 12.

There is likewise a seal 50 between the actuating piston 18 and the brake caliper 12.

In one exemplary arrangement, the seal 50 is folded and can consequently unfold during a corresponding movement of the actuating piston 18.

Thus, the gas-containing piston chamber 44 is sealed off from the outside at the interface between the housing 34 and the brake caliper 12 and in the region of the actuating piston 18.

In order to enable a controlled pressure equalization or venting of the housing 34, at least one venting unit 52 (see FIGS. 1 and 3) is accommodated in the housing. The venting unit 52 enables gas exchange between the piston chamber 44 and the environment.

In the exemplary arrangement illustrated in FIGS. 1 to 3, the venting unit 52 is arranged in housing shell 40.

Alternatively, the venting unit 52 can also be arranged in the further housing shell 38, for example in its end wall or side wall, or in the sleeve-shaped section 42.

In the exemplary arrangement according to FIGS. 1 to 4, the housing 34 has an aperture 53, wherein the venting unit 52 is accommodated in the aperture 53.

Integrally formed on the housing 34 is a collar 54, which surrounds the venting unit 52 and thus protects the venting unit 52 from damage.

The collar 54 is in the form of a circumferential rib.

The venting unit 52 can be seen in detail in FIG. 4.

The venting unit 52 has a gas-permeable filter element 56 and a holding element 58 for the filter element 56.

As an option, the venting unit 52 has a cover 60 for covering the filter element 56.

The cover 60 has a plurality of inlet openings 62 arranged in a side wall of the cover 60.

The cover 60 is firmly connected to the holding element 58, for example latched, adhesively bonded or welded.

The venting unit 52 is fixed on the housing 34 by the holding element 58.

In the exemplary arrangement according to FIG. 4, latching elements 64 are integrally formed on the holding element 58. The holding element 58 protrudes through the aperture 53 in the housing 34 and is latched to the housing 34 by the latching elements 64.

Alternatively, a thread can be formed on the holding element 58, thus enabling the venting unit 52 to be screwed into the housing 34. As a further alternative, the holding element 58 can be adhesively bonded or welded to the housing 34.

A seal 66, for example, a sealing ring, is present between the venting unit 52 and the housing 34, to be more precise between the holding element 58 and the housing 34. This ensures that a gas exchange takes place exclusively via the filter element 56.

Arranged in the holding element 58 is a plurality of venting channels 68, which are covered by the filter element 56.

Adjacent to the outlet openings of the venting channels 68, a support surface 70 is formed, against which the filter element 56 rests, thereby limiting a deformation of the filter element.

The filter element 56 is formed from a hydrophobic and/or oleophobic material.

Moreover, the filter element 56 has a microporous structure.

For example, the filter element 56 consists of polytetrafluoroethylene, for example, of multi-directional expanded polytetrafluoroethylene.

In the exemplary arrangement illustrated in FIG. 4, the filter element 56 is implemented as a membrane, that is, the filter element 56 has a large extent compared to its material thickness.

The filter element 56 is overmoulded along its outer edge with the material that forms the holding element 58. Alternatively, it is conceivable for the filter element 56 to be adhesively bonded or welded to the holding element 58.

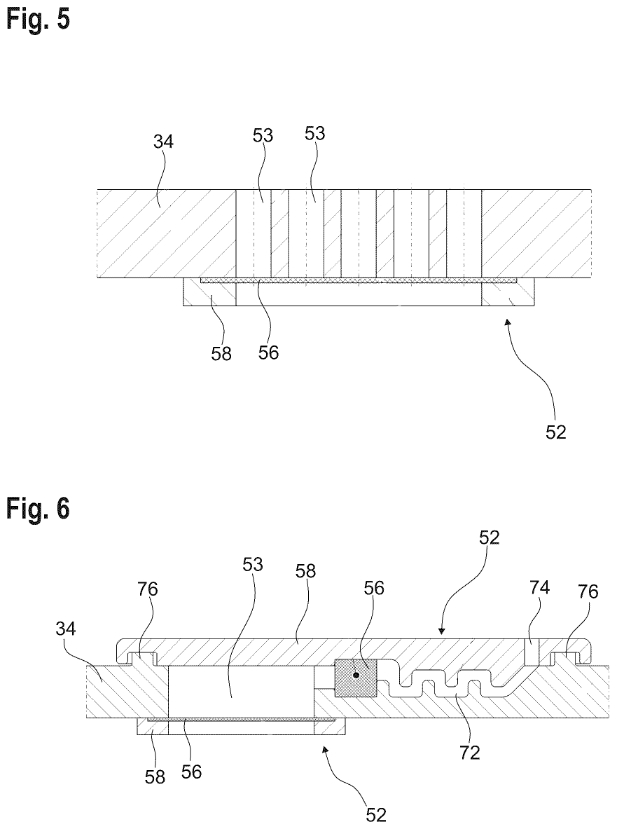

FIG. 5 shows a venting unit 52 according to a further exemplary arrangement, which according to the disclosure can also be present in a vehicle brake 10.

According to the exemplary arrangement illustrated in FIG. 5, the holding element 58 is annular.

The profile of the annular holding element 58 is stepped, ensuring that the filter element 56 is not compressed too much during assembly.

The holding element 58 may be adhesively bonded or welded to the housing 34, for example by ultrasonic welding or high-frequency welding. A gas-tight connection is thus achieved.

During welding, the material of the holding element 58 and/or of the housing 34 is melted and penetrates the porous structure of the filter element 56, thereby ensuring that a reliable connection is achieved.

The filter element 56 is formed, for example, from the same material as the filter element 56 described in conjunction with FIG. 4.

In order to simplify handling during assembly, the filter element 56 can be secured on the holding element 58 in the manner already described in conjunction with FIG. 5, for example by injection moulding, adhesive bonding or welding.

It is also conceivable for the filter element 56 to be overmoulded along its outer edge with the material that forms the housing 34.

In one exemplary arrangement, the venting unit 52 rests against an inner side of the housing 34, thereby protecting the venting unit from mechanical damage. However, it is also conceivable in principle to arrange the venting unit 52 on the outside of the housing 34.

In the region of the venting unit 52, there is a plurality of apertures 53 in the housing 34, wherein the venting unit 52, to be more precise the filter element 56, covers the apertures 53.

By providing a plurality of apertures 53, the support of the filter element 56 is optimized in this exemplary arrangement too.

FIG. 6 shows a venting unit 52 according to yet another exemplary arrangement, which according to the disclosure can also be present in a vehicle brake 10.

For example, FIG. 6 illustrates two venting units 52, wherein one of the two venting units 52 is identical to the venting unit 52 illustrated in FIG. 5.

The further venting unit 52 comprises a holding element 58 which is shaped like a cover and covers the aperture 53 in the housing 34.

In addition, the holding element 58 covers a further region of the housing 34, wherein the housing 34 and the holding element 58 are shaped in such a way that a meandering venting channel 72 is formed between the housing 34 and the holding element 58.

For example, the holding element 58 and the housing 34 have a corrugated region.

The venting channel 72 opens into the aperture 53 and into an opening 74 in the cover-shaped holding element 58.

A filter element 56 is arranged, for example clamped, in the venting channel 72, that is to say between the holding element 58 and the housing 34.

In this case, the filter element 56 is accommodated in a form-fitting manner in the venting channel 72, and therefore defined positioning of the filter element 56 is achieved.

In this case, the filter element 56 is cuboidal.

In a further alternative exemplary arrangement, only one of the two venting units 52 illustrated in FIG. 6 may be present.

An alignment element 76 in the form of an annular projection for aligning the cover-shaped holding element 58 is provided on the housing 34.

The holding element 58 can be connected, for example, adhesively bonded or welded, to the housing 34 in a gas-tight manner along the alignment element 76.

1. An electromechanical vehicle brake for a motor vehicle, comprising a housing with a piston chamber containing gas, an actuating piston for a brake lining, and an electric motor for driving the actuating piston, wherein the actuating piston can be moved optionally between a retracted position and an extended position, wherein the actuating piston is movably accommodated in the housing, such that an end of the actuating piston directed towards the brake lining protrudes from the housing and an opposite end of the actuating piston is accommodated in the housing, and wherein at least one venting unit is accommodated in the housing in order to allow a gas exchange between the piston chamber and the environment, wherein the venting unit comprises a gas-permeable filter element and a holding element for the filter element, and the venting unit is fixed on the housing by the holding element.

2. The electromechanical vehicle brake according to claim 1, wherein the housing has at least one aperture, wherein the venting unit is accommodated in the at least one aperture r covers the at least one aperture.

3. The electromechanical vehicle brake according to claim 1, wherein latching elements are integrally formed on the holding element, wherein the holding element protrudes through an aperture in the housing and is latched on the housing.

4. The electromechanical vehicle brake according to claim 1, wherein a thread is formed on the holding element, and the holding element is screwed into an aperture in the housing.

5. The electromechanical vehicle brake according to claim 1, wherein the holding element is adhesively bonded or welded to the housing.

6. The electromechanical vehicle brake according to claim 1, wherein the filter element is overmoulded along its outer edge with the material that forms the holding element.

7. The electromechanical vehicle brake according to claim 1, wherein a seal is arranged between the venting unit and the housing.

8. The electromechanical vehicle brake according to claim 1, wherein a collar is integrally formed on the housing, and the venting unit is surrounded by the collar.

9. The electromechanical vehicle brake according to claim 1, wherein at least one venting channel is formed in the holding element, which channel is covered by the filter element.

10. The electromechanical vehicle brake according to claim 1, wherein the holding element is annular.

11. The electromechanical vehicle brake according to claim 1, wherein the venting unit has a cover for covering the filter element, wherein the cover has at least one inlet opening arranged in a side wall of the cover.

12. The electromechanical vehicle brake according to claim 1, wherein the housing and the holding element are shaped in such a way that a meandering venting channel is formed between the housing and the holding element.

13. The electromechanical vehicle brake according to claim 2, wherein latching elements are integrally formed on the holding element, wherein the holding element protrudes through an aperture in the housing and is latched on the housing.

14. The electromechanical vehicle brake according to claim 2, wherein a thread is formed on the holding element, and the holding element is screwed into an aperture in the housing.

15. The electromechanical vehicle brake according to claim 2, wherein the holding element is adhesively bonded or welded to the housing.

16. The electromechanical vehicle brake according to claim 15, wherein the filter element is overmoulded along its outer edge with the material that forms the holding element.

17. The electromechanical vehicle brake according to claim 7, wherein the seal is arranged between the holding element and the housing.

18. The electromechanical vehicle brake according to claim 17, wherein a collar is integrally formed on the housing, and the venting unit is surrounded by the collar.

19. The electromechanical vehicle brake according to claim 7, wherein the venting unit has a cover for covering the filter element, wherein the cover has at least one inlet opening arranged in a side wall of the cover.

20. The electromechanical vehicle brake according to claim 7, wherein the housing and the holding element are shaped in such a way that a meandering venting channel is formed between the housing and the holding element.
